(19) United States
(12) Patent Application Publication
(10) Pub. No.: US 2025/0112531 A1
(43) Pub. Date: Apr. 3, 2025

(54) STATOR MANUFACTURING METHOD, STATOR, AND MOTOR

(71) Applicant: NIDEC CORPORATION, Kyoto (JP)

(72) Inventors: Hitoshi KATSURADA, Kyoto (JP); Takeshi HONDA, Kyoto (JP); Yuya DANJO, Kyoto (JP)

(21) Appl. No.: 18/898,681

(22) Filed: Sep. 27, 2024

(30) Foreign Application Priority Data
Sep. 29, 2023 (JP) 2023-170703

(51) Int. Cl. H02K 15/02; H02K 1/16; H02K 3/34; H02K 15/10

(52) U.S. Cl. CPC H02K 15/021; H02K 1/16; H02K 3/345; H02K 15/10; H02K 2215/00

(57) ABSTRACT

A method of manufacturing a stator includes a pressing step of punching an iron core piece forming part from a steel sheet by press molding, a mounting step of mounting insulating paper on each of a plurality of protruding portions arranged in a circumferential direction on an outer peripheral surface of a columnar roll member rotating about a central axis and extending along the central axis, and a stacking step of spirally winding the iron core piece forming part around the outer peripheral surface of the roll member while deforming it in one direction in a width direction by rotating the roll member in a state where the protruding portion and the insulating paper are inserted into a slot, and stacking the iron core piece forming part in a thickness direction.

### CROSS-REFERENCE TO RELATED APPLICATIONS

The present invention claims priority under 35 U.S.C. § 119 to Japanese Patent Application No. 2023-170703 filed on Sep. 29, 2023, the entire content of which is incorporated herein by reference.

### FIELD OF THE INVENTION

The present invention relates to a stator manufacturing method, a stator, and a motor.

### BACKGROUND

There is known a stator including a laminated core in which a plurality of electromagnetic steel sheets is laminated, and insulating paper accommodated in a slot of the laminated core. As such a stator, for example, there is disclosed a motor core including a laminated steel sheet part in which a plurality of electromagnetic steel sheets is laminated. The electromagnetic steel sheet includes a tooth portion around which a winding is wound, and a sheet-like insulating member is inserted into a slot provided between the tooth portions.

Generally, in a method of manufacturing a stator, a laminated core is formed by laminating electromagnetic steel sheets, and then insulating paper is inserted into a slot of the laminated core in the axial direction. The electromagnetic steel sheet is formed by press molding, for example. A protrusion is formed at an end of the electromagnetic steel sheet punched by press molding.

Therefore, there is a possibility that the insulating paper is caught by the protrusion when the insulating paper is inserted in the axial direction into the slot of the laminated core in which the electromagnetic steel sheets are laminated. Therefore, there is a demand for a method of manufacturing a stator enabling insulating paper to be inserted into a slot of a laminated core more easily.

### SUMMARY

A stator manufacturing method according to an exemplary embodiment of the present invention is a method of manufacturing a stator including a laminated core and insulating paper. The laminated core is obtained by spirally winding a plate-shaped iron core piece forming part having a band-shaped back yoke forming portion and a plurality of tooth portions protruding from the back yoke forming portion to one side in a width direction of the back yoke forming portion while deforming the plate-shaped iron core piece forming part to one side in the width direction, and the insulating paper is inserted into a slot located between the tooth portions. The stator manufacturing method includes a pressing step of punching the iron core piece forming part from a steel sheet by press molding, a mounting step of mounting the insulating paper on each of a plurality of protruding portions arranged in a circumferential direction on an outer peripheral surface of a columnar roll member rotating about a central axis and extending along the central axis, and a stacking step of spirally winding the iron core piece forming part around the outer peripheral surface of the roll member while deforming it in one direction in the width direction by rotating the roll member in a state where the protruding portion and the insulating paper are inserted into the slot, and stacking the iron core piece forming part in the thickness direction.

A stator according to an exemplary embodiment of the present invention is a stator including a laminated core and insulating paper. The laminated core includes a cylindrical core back portion, and a plurality of tooth portions extending radially inward from a radially inner peripheral side of the core back portion, and steel sheets are laminated in a thickness direction in the laminated core. The insulating paper is accommodated in a slot located between the tooth portions. One surface in the thickness direction of the steel sheet has a curved surface portion at an end, and the other surface in the thickness direction of the steel sheet has a protrusion at an end. The one surface is located on one side in the stacking direction of some steel sheets among the steel sheets constituting the laminated core, and the other surface is located on one side in the stacking direction of the other steel sheets among the steel sheets constituting the laminated core.

A motor according to an exemplary embodiment of the present invention is a motor including the stator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a schematic configuration of a stator according to a first embodiment;

FIG. 2 is a plan view illustrating a schematic configuration of a laminated core;

FIG. 3 is a cross-sectional view schematically illustrating a shape of an end portion of a strip member;

FIG. 4A is a diagram for explaining punching by pressing;

FIG. 4B is a diagram for explaining the shape of an end portion of a material punched by the pressing;

FIG. 5 is a perspective view schematically illustrating a schematic configuration of a roll member;

FIG. 6 is a plan view of the roll member;

FIG. 7 is a flowchart illustrating a method of manufacturing a stator according to the first embodiment;

FIG. 8 illustrates punching of a steel sheet;

FIG. 9 is a cross-sectional view schematically illustrating a shape of an end portion of a steel sheet;

FIG. 10 is a plan view illustrating a state in which insulating paper is mounted on a roll member;

FIG. 11 is a plan view illustrating a schematic configuration of a laminated core according to a second embodiment;

FIG. 12 is a cross-sectional view of a laminated core;

FIG. 13 illustrates punching of a steel sheet;

FIG. 14 is a plan view of an iron core piece forming part punched out from a steel sheet;

FIG. 15 is a diagram for describing a state in which one surfaces of two iron core piece forming parts in a thickness direction face each other;

FIG. 16 is a cross-sectional view schematically illustrating a state in which two iron core piece forming parts are overlapped;

FIG. 17 is a diagram for describing a state in which an iron core piece forming part is wound around a roll member; and

FIG. 18 is a diagram for describing how an iron core piece forming part moves in the axial direction with respect to the roll member.

### DETAILED DESCRIPTION

Hereinafter, exemplary embodiments of the present invention will be described with reference to the drawings. The same or corresponding parts in the drawings are denoted by the same reference numerals, and the description thereof will not be repeated. In addition, the respective drawings do not faithfully show the dimensions of actual constituent members, the dimensional ratios of the constituent members, and the like.

The following description shows that a direction parallel to a central axis P of a laminated core 10 is referred to as an axial direction, a direction orthogonal to the central axis P is referred to as a radial direction, and a direction along an arc centered on the central axis P is referred to as a circumferential direction.

The following description also shows that the expression, “fix”, “connect”, “attach”, or the like, is used not only when members are directly fixed to each other, but also when members are fixed to each other with another member interposed therebetween, for example. That is, in the following description, the expression such as fixing includes the meaning of direct and indirect fixing between members.

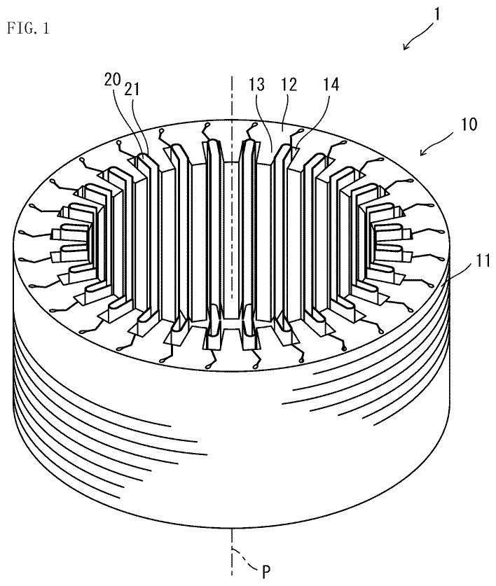

A method of manufacturing a stator 1 according to a first exemplary embodiment of the present invention will be described with reference to FIGS. 1 to 10. The stator 1 is a motor stator. The stator 1 is manufactured using a roll member 9. First, the stator 1 manufactured in the present embodiment will be briefly described with reference to FIGS. 1 to 3.

As illustrated in FIG. 1, the stator 1 includes a laminated core 10 and insulating paper 20. The laminated core 10 has a cylindrical shape extending along the central axis P. In the present embodiment, the laminated core 10 is a lamination in which a strip member 11 extending spirally about the central axis P is stacked in the thickness direction.

The laminated core 10 includes a cylindrical core back portion 12 and a plurality of tooth portions 13 extending radially inward from the radially inner peripheral side of the core back portion 12.

When the laminated core 10 is viewed in the axial direction, a slot 14 extending in the axial direction and opening radially inward is located between the adjacent tooth portions 13. The insulating paper 20 is accommodated in the slot 14. A coil wire (not illustrated) is inserted inside the insulating paper 20.

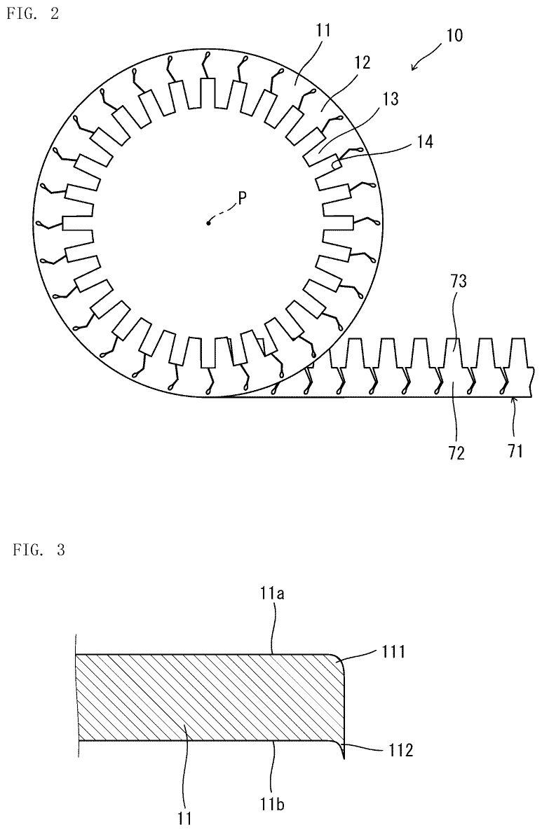

FIG. 2 is an exploded plan view illustrating the laminated core 10. The strip member 11 is obtained by spirally winding the iron core piece forming part 71 punched by pressing.

As illustrated in FIG. 3, the strip member 11 has a first surface 11a that is one surface in the thickness direction and a second surface 11b that is the other surface in the thickness direction. The first surface 11a of the strip member 11 has a curved surface portion 111 at an end. The second surface 11b of the strip member 11 has a protrusion 112 at an end. The curved surface portion 111 and the protrusion 112 are formed by punching a steel sheet by pressing.

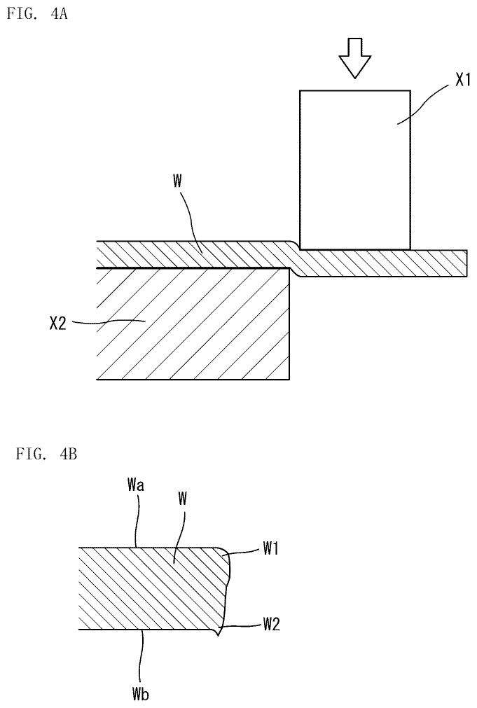

FIGS. 4A and 4B are diagrams for explaining punching by general pressing. As illustrated in FIG. 4A, in the punching by pressing, a material W placed on a die X2 is punched by moving a punch X1 downward with respect to the die X2. The material W placed on the die X2 is sheared at the boundary portion between the punch X1 and the die X2.

As a result, as illustrated in FIG. 4B, a curved surface portion W1 is formed at an end of one surface Wa in the thickness direction of the punched material W. A protrusion W2 is formed at an end of the other surface Wb in the thickness direction of the material W. As described above, in the punching by pressing, the curved surface portion W1 is formed at the end on the rear side in the direction in which the punch X1 moves with respect to the die X2, of the surfaces in the thickness direction of the material W. The protrusion W2 is formed at the end on the front side in the direction in which the punch X1 moves with respect to the die X2.

As illustrated in FIG. 1, the insulating paper 20 is accommodated in the slot 14. Specifically, the insulating paper 20 is positioned between an inner surface of the slot 14 and a coil wire (not illustrated) inserted into the slot 14. The insulating paper 20 has a rectangular shape elongated in the axial direction of the laminated core 10. An end portion 21 in the longitudinal direction of the insulating paper 20 protrudes in the axial direction from the slot 14.

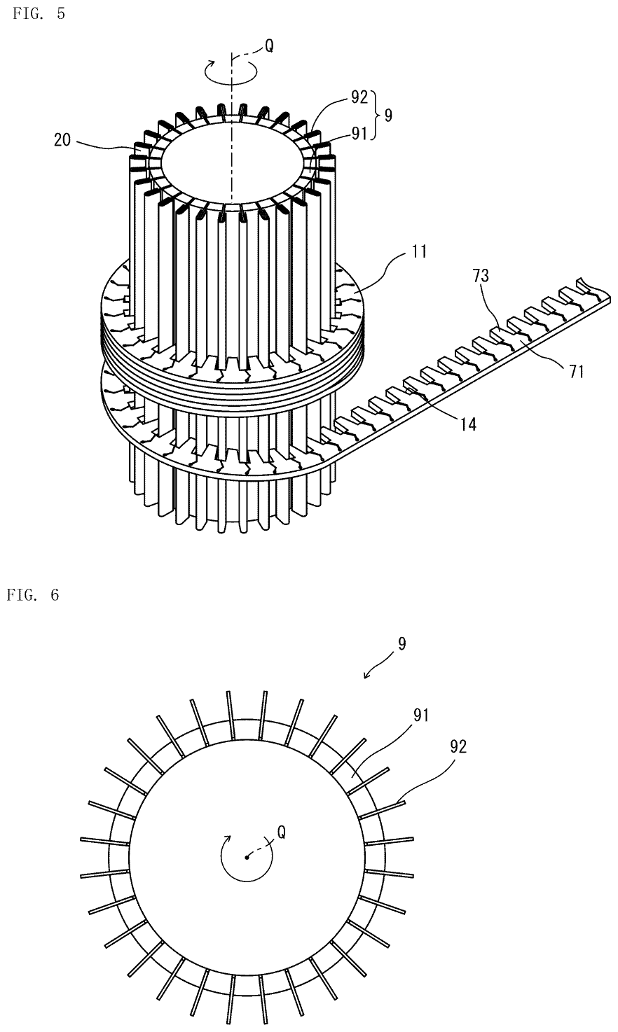

Next, the roll member 9 used in manufacturing the stator 1 will be briefly described with reference to FIGS. 5 and 6.

As illustrated in FIG. 5, the roll member 9 has a columnar shape. The roll member 9 includes a main body portion 91 and a protruding portion 92. As illustrated in FIG. 5, the iron core piece forming part 71 is wound around the outer peripheral surface of the roll member 9.

The main body portion 91 of the roll member 9 has a columnar shape. The axial length of the main body portion 91 is longer than the axial length of the laminated core 10. The diameter of the outer peripheral surface of the main body portion 91 is equal to the diameter of the inner peripheral surface of the laminated core 10 configured of the radially inner end surfaces of the plurality of tooth portions 13 of the laminated core 10.

As illustrated in FIGS. 5 and 6, the protruding portion 92 protrudes outward from the outer peripheral surface of the main body portion 91. The protruding portion 92 has a plate shape extending along the central axis Q of the main body portion 91. The thickness direction of the protruding portion 92 is a circumferential direction of the main body portion 91. In the present embodiment, the axial length of the protruding portion 92 is equal to the axial length of the main body portion 91. The protruding portions 92 are arranged in the circumferential direction of the main body portion 91. The protruding portion 92 has a shape and a size that can be inserted into the slot 14 in the laminated core 10.

The roll member 9 has the same number of protruding portions 92 as the number of slots 14 of the laminated core 10. The protruding portions 92 are inserted between the plurality of tooth forming portions 73 in the iron core piece forming part 71 wound around the outer peripheral surface of the main body portion 91.

The roll member 9 is rotated about the central axis Q by a driving device (not illustrated). As the roll member 9 rotates, the protruding portions 92 move in the rotation direction of the roll member 9. As a result, the tooth forming portions 73 move in the rotation direction by the protruding portion 92. Therefore, the iron core piece forming part 71 is wound around the outer peripheral surface of the main body portion 91.

Next, an exemplary stator manufacturing method for manufacturing the stator 1 will be described with reference to FIGS. 1, 3, 5, and 7 to 10.

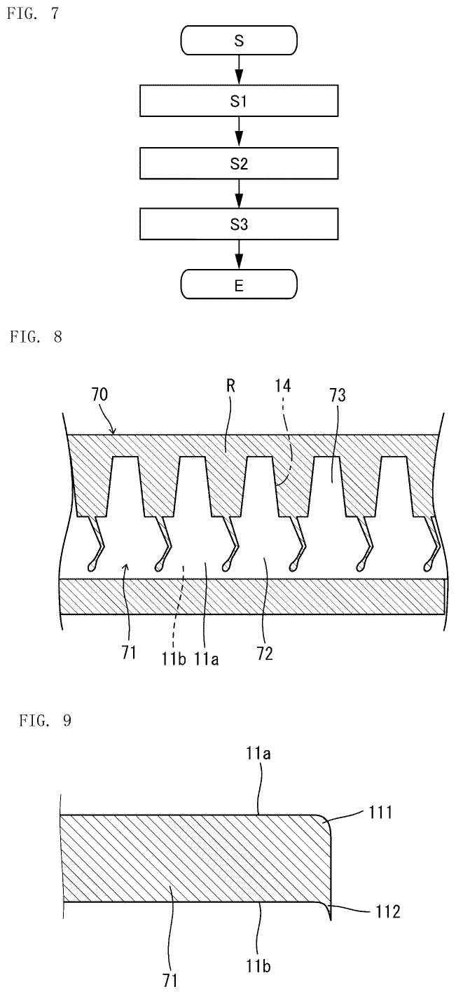

FIG. 7 is a flowchart showing an example of a method of manufacturing the stator 1. As illustrated in FIG. 7, the method of manufacturing the stator 1 includes a pressing step S1, a mounting step S2, and a stacking step S3.

In the pressing step S1, the band-shaped iron core piece forming part 71 is punched out from the steel sheet 70 that is a magnetic material by press molding. The iron core piece forming part 71 serves as the strip member 11 in the laminated core 10.

FIG. 8 illustrates an example of punching of the steel sheet 70. In FIG. 8, a region R where the steel sheet 70 is punched is hatched. In the pressing step S1, the region R of the steel sheet 70 is punched by a punch. As a result, the plate-shaped iron core piece forming part 71, having the band-shaped back yoke forming portion 72 and the plurality of tooth forming portions 73 protruding to one side in the width direction of the back yoke forming portion 72, is formed. The slot 14 of the laminated core 10 is formed between the tooth forming portions 73 adjacent to each other in the arrangement direction of the plurality of tooth forming portions 73.

As described above, the iron core piece forming part 71 formed by press molding has the curved surface portion 111 and the protrusion 112 at the end. FIG. 9 schematically illustrates the shape of an end portion of the iron core piece forming part 71 formed by press molding. The surface of the iron core piece forming part 71 having the curved surface portion 111 at the end is the first surface 11a of the strip member 11 of the laminated core 10. The surface of the iron core piece forming part 71 having the protrusion 112 at the end is the second surface 11b of the strip member 11 of the laminated core 10.

As illustrated in FIG. 10, in the mounting step S2, the insulating paper 20 is mounted one by one to each of the plurality of protruding portions 92 of the roll member 9. Specifically, the insulating paper 20 is bent at the center portion in the width direction. The insulating paper 20 is mounted on the protruding portion 92 in a posture in which the bent portion is located at the tip end portion in the protruding direction of the protruding portion 92 and both end portions in the width direction are located at the base end portion of the protruding portion 92. In the present embodiment, as illustrated in FIG. 5, the length of the insulating paper 20 in the longitudinal direction is equal to the axial length of the protruding portion 92.

As described above, the protruding portion 92 is inserted between the plurality of tooth forming portions 73 in the iron core piece forming part 71. Therefore, the insulating paper 20 mounted on the protruding portion 92 is inserted into the slot 14 when the iron core piece forming part 71 is wound around the roll member 9 in the stacking step S3 to be described later.

As illustrated in FIG. 5, in the stacking step S3, the iron core piece forming part 71 is spirally wound, and the iron core piece forming part 71 is stacked in the thickness direction. Specifically, the protruding portion 92 and the insulating paper 20 are inserted into the slot 14 formed between the adjacent tooth forming portions 73 in the iron core piece forming part 71 formed in the pressing step S1. Then, the roll member 9 is rotated. The iron core piece forming part 71 is spirally wound on the outer peripheral surface of the roll member 9 while being deformed to one side in the width direction by the rotation of the roll member 9.

The portion of the iron core piece forming part 71 to be newly wound around the outer peripheral surface of the roll member 9 pushes the iron core piece forming part 71 already spirally wound around the outer peripheral surface of the roll member 9 toward the winding start side. As a result, the iron core piece forming part 71 is laminated in the thickness direction to form the laminated core 10. The back yoke forming portion 72 laminated in the thickness direction becomes the core back portion 12 of the laminated core 10. The tooth forming portions 73 stacked in the thickness direction become the tooth portions 13 of the laminated core 10.

Thereafter, the laminated core 10 and the insulating paper 20 are removed from the axial end of the roll member 9. As a result, the stator 1 including the laminated core 10 and the insulating paper 20 is manufactured. The laminated core 10 of the stator 1 includes the cylindrical core back portion 12 and the plurality of tooth portions 13 extending radially inward from the radially inner peripheral side of the core back portion 12, and the strip member 11 is stacked in the thickness direction. The insulating paper 20 is accommodated in the slot 14 located between the tooth portions 13.

The exemplary stator manufacturing method according to the present embodiment described above is a method of manufacturing the stator 1 including the laminated core 10 and the insulating paper 20. The laminated core 10 is obtained by spirally winding the plate-shaped iron core piece forming part 71 while deforming in one side in the width direction. The plate-shaped iron core piece forming part 71 includes the band-shaped back yoke forming portion 72 and the plurality of tooth forming portions 73 protruding from the back yoke forming portion 72 to one side in the width direction of the back yoke forming portion 72. The insulating paper 20 is to be inserted into the slot 14 located between the tooth forming portions 73. The method of manufacturing the stator 1 includes a pressing step S1 of punching the iron core piece forming part 71 from the steel sheet 70 by press molding, the mounting step S2 of mounting the insulating paper 20 on each of the plurality of protruding portions 92 arranged in the circumferential direction on the outer peripheral surface of the columnar roll member 9 rotating about the central axis Q and extending along the central axis Q, and the stacking step S3 of spirally winding the iron core piece forming part 71 around the outer peripheral surface of the roll member 9 while deforming the iron core piece forming part 71 in one direction in the width direction by rotating the roll member 9 in a state where the protruding portion 92 and the insulating paper 20 are inserted into the slot 14, and stacking the iron core piece forming part 71 in the thickness direction.

In general, the iron core piece forming part 71 formed by press molding has the protrusion 112 formed by press molding at an end. Therefore, when the insulating paper 20 is inserted in the axial direction into the slot 14 of the laminated core 10 obtained by spirally winding the iron core piece forming part 71 while deforming it in one side in the width direction, there is a possibility that the insulating paper 20 is caught by the protrusion 112.

On the other hand, according to the above-described method, the insulating paper 20 can be inserted into the slot 14 when the iron core piece forming part 71 formed by press molding is wound in a spiral shape while being deformed in one direction in the width direction. As a result, the insulating paper 20 can be easily inserted into the slot 14 without being affected by the protrusion 112 of the iron core piece forming part 71. Accordingly, it is possible to provide a method of manufacturing the stator 1 that enables the insulating paper 20 to be more easily inserted into the slot 14 of the laminated core 10.

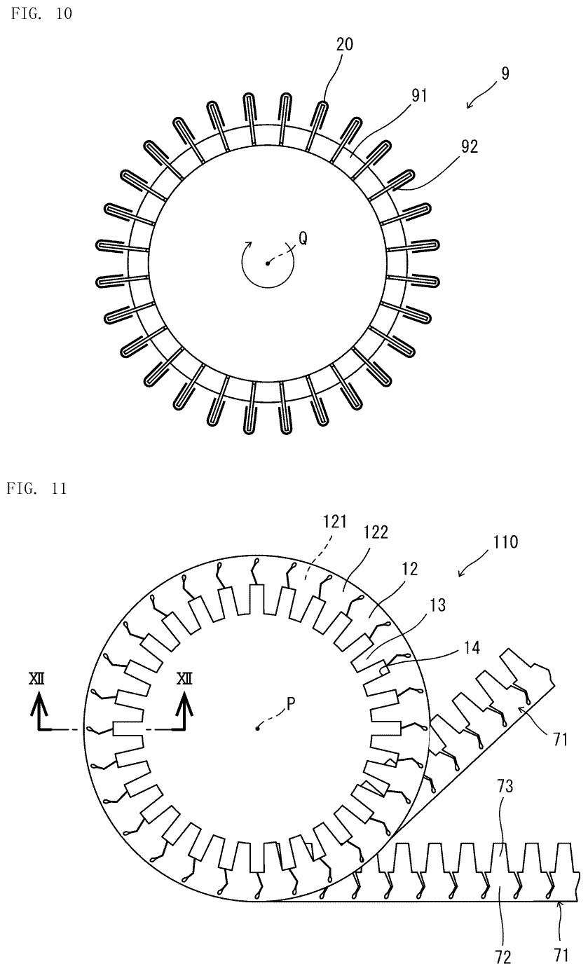

A method of manufacturing a stator according to a second exemplary embodiment of the present invention will be described with reference to FIGS. 11 to 18. A laminated core 110 of the stator manufactured in the present embodiment includes two strip members 121 and 122. Hereinafter, the same components as those of the first embodiment are denoted by the same reference signs, and will not be described.

The stator manufactured in the present embodiment includes the laminated core 110 and the insulating paper 20. The laminated core 110 is a lamination in which two strip members 121 and 122 extending spirally around the central axis P are stacked in the thickness direction. As in the first embodiment, the laminated core 110 includes a cylindrical core back portion 12, a plurality of tooth portions 13, and a plurality of slots 14. FIG. 11 is an exploded plan view illustrating the laminated core 110.

The strip members 121 and 122 have the same configuration as the strip member 11 of the first embodiment. That is, as illustrated in FIG. 12, each of the strip members 121 and 122 has a first surface 11a that is one surface in the thickness direction and a second surface 11b that is the other surface in the thickness direction. The first surface 11a of each of the strip members 121 and 122 has a curved surface portion 111 at an end. The second surface 11b of each of the strip member 121 and 122 has a protrusion 112 at an end.

As illustrated in FIG. 12, in the laminated core 110, the strip member 121 and the strip member 122 are alternately stacked in the thickness direction when viewed in a cross section. The first surface 11a of the strip member 121 is located on one side in the stacking direction. The second surface 11b of the strip member 122 is located on the one side in the stacking direction.

That is, in the present embodiment, the first surface 11a of one strip member 121 of the two strip members is located on one side in the stacking direction. The second surface 11b of the other strip member 122 of the two strip members is located on one side in the stacking direction. As described above, in the laminated core 110, the surfaces of the strip member 121 and 122 are not disposed regularly in one direction in the stacking direction. In the present specification, the state in which the surfaces of the strip members are not aligned in one direction in the stacking direction refers to a state in which a surface of a strip member having a curved surface portion at an end and a surface of a strip member having a protrusion at an end are located on the same side in the stacking direction.

Next, an exemplary stator manufacturing method of manufacturing the stator of the present embodiment will be described. The method of manufacturing the stator includes a pressing step S11, a mounting step S12, and a stacking step S13.

In the pressing step S11 of the present embodiment, a plurality of band-shaped iron core piece forming parts 71 are punched out side by side from the steel sheet 70 that is a magnetic material by press molding. In the present embodiment, the case where two iron core piece forming parts 71 are punched out side by side in the pressing step S11 will be described. The two iron core piece forming parts 71 serve as the strip members 121 and 122 in the laminated core 110.

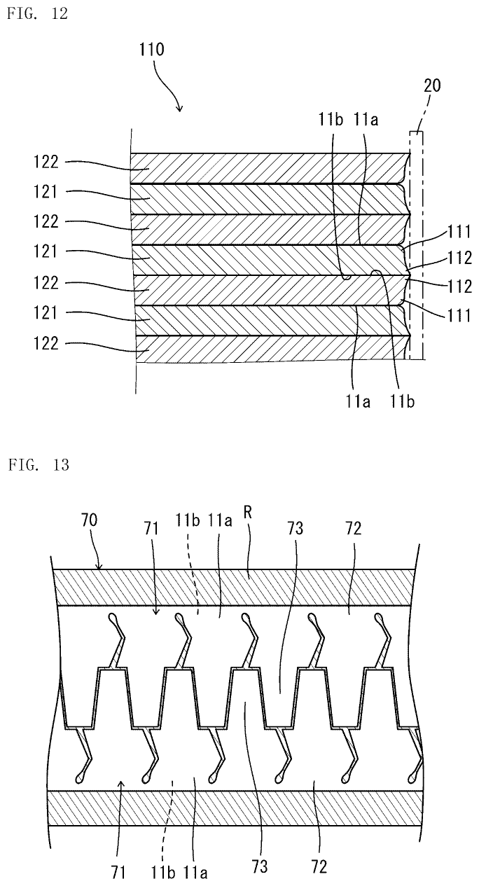

FIG. 13 illustrates an example of punching of the steel sheet 70. As illustrated in FIG. 13, the back yoke forming portions 72 of the two iron core piece forming parts 71 extend in the longitudinal direction of the steel sheet 70. The plurality of tooth forming portions 73 of one iron core piece forming part 71 of the two iron core piece forming parts 71 protrude toward the back yoke forming portion 72 of the other iron core piece forming part 71. The plurality of tooth forming portions 73 of the other iron core piece forming part 71 of the two iron core piece forming parts 71 protrude toward the back yoke forming portion 72 of one iron core piece forming part 71.

The tooth forming portion 73 of one iron core piece forming part 71 is located between the tooth forming portions 73 adjacent to each other in the longitudinal direction in the other iron core piece forming part 71. As described above, in the two iron core piece forming parts 71, the directions in which the plurality of tooth forming portions 73 protrude are opposite to each other. Therefore, two iron core piece forming parts 71 facing each other are formed by punching the region R. FIG. 14 illustrates two iron core piece forming parts 71 punched out from the steel sheet 70.

When the punch moves with respect to the steel sheet 70 illustrated in FIG. 13 and punches out the region R, the curved surface portion 111 is formed at an end of the surface pressed by the punch, of the surfaces in the thickness direction of the iron core piece forming part 71 illustrated in FIG. 14. Therefore, the surface pressed by the punch becomes the first surfaces 11a of the strip members 121 and 122. The protrusion 112 is formed at an end of a surface opposite to the surface pressed by the punch. Therefore, the opposite surface becomes the second surfaces 11b of the strip members 121 and 122.

Since the mounting step S12 of the present embodiment is similar to the mounting step S2 of the first embodiment, the description thereof will be omitted.

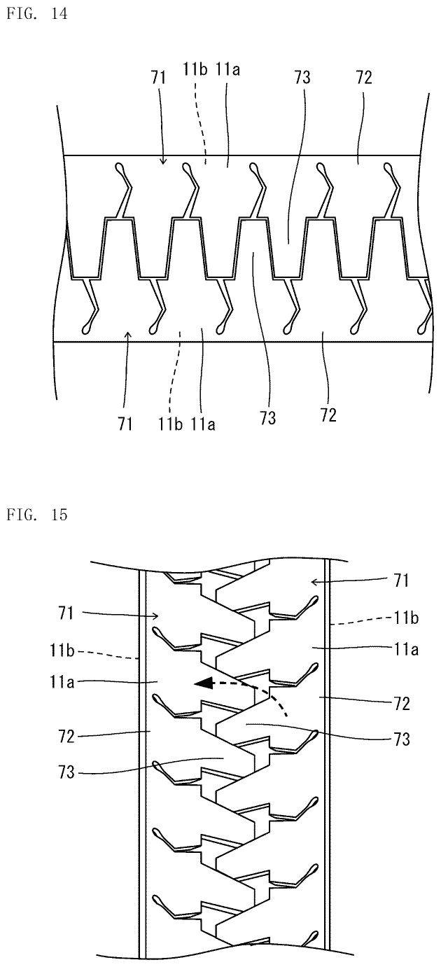

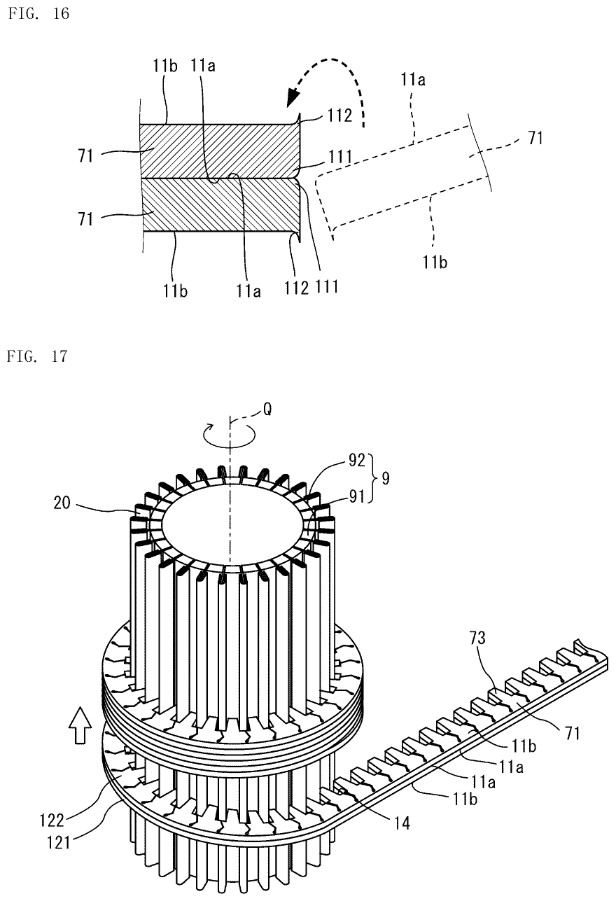

In the stacking step S13 of the present embodiment, as illustrated in FIGS. 15 and 16, the two iron core piece forming parts 71 are overlapped in the thickness direction with their first surfaces 11a facing each other.

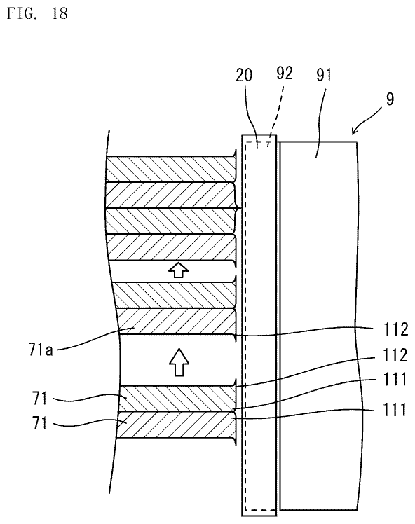

Then, as illustrated in FIG. 17, the two iron core piece forming parts 71 are spirally wound on the outer circumferential surface of the roll member 9 while being deformed in one direction in the width direction by the rotation of the roll member 9 in a state of being overlapped in the thickness direction. When the roll member 9 rotates, as illustrated in FIG. 18, the portion of the two iron core piece forming parts 71 to be newly wound around the outer peripheral surface of the roll member 9 pushes the iron core piece forming part 71 already spirally wound around the outer peripheral surface of the roll member 9 toward the winding start side. As a result, the iron core piece forming part 71 is stacked in the thickness direction.

As illustrated in FIG. 18, the first surfaces 11a of the two iron core piece forming parts 71 face each other. That is, the second surfaces 11b on the outer side in the thickness direction of the two iron core piece forming parts 71 face the second surfaces 11b of the iron core piece forming parts 71a adjacent in the stacking direction of the two iron core piece forming parts 71. Therefore, when the two iron core piece forming parts 71 move in the thickness direction by the rotation of the roll member 9, the second surface 11b of the iron core piece forming part 71 and the second surface 11b of the iron core piece forming part 71a come into contact with each other. As a result, the protrusion 112 of the iron core piece forming part 71 and the protrusion 112 of the iron core piece forming part 71a come into contact with each other, and the two protrusions 112 protrude in a direction intersecting the thickness direction of the two iron core piece forming parts 71. This makes it difficult for the insulating paper 20 to come off from the slot 14.

In the present embodiment, the two iron core piece forming parts 71 are overlapped in the thickness direction with the first surfaces 11a facing each other. However, the two iron core piece forming parts may be overlapped in the thickness direction with the second surfaces 11b facing each other. The two iron core piece forming parts 71 may be overlapped in the thickness direction such that the first surface 11a of one iron core piece forming part 71 and the second surface 11b of the other iron core piece forming part 71 face each other.

In the pressing step S11 of the exemplary stator manufacturing method according to the present embodiment described above, the two iron core piece forming parts 71 are punched out side by side from the steel sheet 70. In the stacking step S13, the two iron core piece forming parts 71 are spirally wound on the outer circumferential surface of the roll member 9 while being deformed in one direction in the width direction by the rotation of the roll member 9 in a state of being overlapped in the thickness direction, so that the two iron core piece forming parts 71 are stacked in the thickness direction thereof.

As a result, it is possible to form a laminated core by spirally stacking the two iron core piece forming parts 71, punched out from the steel sheet 70, in an overlapped state. Therefore, the laminated core 110 can be efficiently formed.

Further, the insulating paper 20 can be inserted into the slot 14 when the laminated core 110 is formed by spirally winding the two iron core piece forming parts 71. As a result, the insulating paper 20 can be easily inserted into the slot 14 without being affected by the protrusions 112 of the two iron core piece forming parts 71.

In addition, in the stacking step S13 of the present embodiment, the two iron core piece forming parts 71 are spirally wound on the outer peripheral surface of the roll member 9 while being deformed to one side in the width direction by the rotation of the roll member 9 in a state where the second surfaces 11b, which are one surfaces in the thickness direction having the protrusions 112 formed at the ends thereof by the pressing step S11, or the first surfaces 11a, which are the other surfaces in the thickness direction having the curved surface portions 111 formed at the ends thereof by the pressing step S11, face each other, and the two iron core piece forming parts 71 are stacked in the thickness direction.

As a result, the two iron core piece forming parts 71 punched out from the steel sheet 70 are overlapped in the thickness direction and spirally wound around the roll member 9 in a state where the second surfaces 11b having the protrusions 112 formed at the ends by the pressing step S11 or the first surfaces 11a having the curved surface portions 111 formed at the ends by the pressing step S11 face each other. Therefore, in the laminated core 110 to be formed, the protrusions 112 are positioned to face each other in the two iron core piece forming parts 71. In that case, when the insulating paper 20 is inserted into the slot 14 in the axial direction of the laminated core 110, the insulating paper 20 is easily caught by the protrusions 112.

On the other hand, the insulating paper 20 is inserted into the slot 14 when the two iron core piece forming parts 71 are spirally wound around the roll member 9. As a result, the insulating paper 20 can be easily inserted into the slot 14 without being affected by the protrusions 112 of the two iron core piece forming parts 71.

In addition, the stator manufactured by the exemplary manufacturing method of the present embodiment includes the laminated core 110 having the cylindrical core back portion 12 and the plurality of tooth portions 13 extending radially inward from the radially inner peripheral side of the core back portion 12, in which two strip members 121 and 122 are stacked in the thickness direction, and the insulating paper 20 accommodated in the slot 14 located between the tooth portions 13. The first surface 11a of each of the strip members 121 and 122 has the curved surface portion 111 at an end. The second surface 11b of each of the strip members 121 and 122 has the protrusion 112 at an end. The first surface 11a is located on one side in the stacking direction of one strip member 121 of the two strip members 121 and 122 constituting the laminated core 110. The second surface 11b is located on one side in the stacking direction of the other strip member 122 of the two strip members 121 and 122 constituting the laminated core 110.

The laminated core 110 of the present embodiment can be formed by stacking the surfaces of the strip members 121 and 122 formed by punching by pressing without disposing the surfaces regularly in one direction in the stacking direction. Therefore, the laminated core 110 that can be easily manufactured can be realized.

In addition, the surface located on one side in the stacking direction of the strip members 121 and 122 constituting the laminated core 110 includes the first surface 11a having the curved surface portion 111 at an end formed by punching by pressing and the second surface 11b having the protrusion 112 at an end formed by punching by pressing. Therefore, as compared with the case where all the surfaces located on one side in the stacking direction of the strip members 121 and 122 constituting the laminated core 110 are the first surfaces 11a having the curved surface portions 111, the insulating paper 20 accommodated in the slot 14 is less likely to come off to one side in the stacking direction. As a result, it is possible to realize a configuration in which the insulating paper 20 can be more reliably held in the slot 14.

In the present embodiment, each of the strip members 121 and 122 is a member that extends spirally about the axis and can be stacked in the thickness direction. In the present embodiment, the laminated core 110 is a lamination in which the strip members 121 and 122 are stacked in the thickness direction. Therefore, it is possible to realize the laminated core 110 that can be easily formed. Therefore, a stator capable of improving productivity is obtained.

In addition, in the present embodiment, the laminated core 110 is a lamination in which two strip members 121 and 122 are stacked in the thickness direction in a state of being overlapped in the thickness direction thereof.

Also in the laminated core 110 of the present embodiment, the laminated core 110 can be formed by stacking the two iron core piece forming parts 71 in the thickness direction in a state of being overlapped in the thickness direction without aligning the surfaces of the two iron core piece forming parts 71 formed by punching by pressing in one direction in the stacking direction. Therefore, it is possible to realize the laminated core 110 that can be more easily formed. Accordingly, a stator capable of improving the productivity is obtained.

In addition, the insulating paper 20 inserted into the slot 14 is less likely to come off to one side in the stacking direction, as compared with the case where the surfaces located on one side in the stacking direction of the strip members 121 and 122 constituting the laminated core 110 are all the first surfaces 11a having the curved surface portions 111. As a result, it is possible to realize a configuration in which the insulating paper 20 can be more reliably held in the slot 14.

The foregoing description concerns the embodiments of the present invention; however, the foregoing embodiments are merely examples for embodying the present invention. Accordingly, the present invention is not limited to the embodiments described above, and the embodiments described above may be appropriately modified and implemented without departing from the scope of the present invention.

In each of the above embodiments, the central axis Q of the roll member 9 extends in the vertical direction. However, the central axis of the roll member may extend in the horizontal direction. The central axis of the roll member may extend in a direction inclined with respect to the vertical direction or in a direction inclined with respect to the horizontal direction.

In each of the above embodiments, the axial length of the protruding portion 92 is equal to the axial length of the main body portion 91. However, the axial length of the protruding portion may be shorter than the axial length of the main body portion. The axial length of the protruding portion may be longer than the axial length of the main body portion.

In each of the above embodiments, the length of the insulating paper 20 in the longitudinal direction is equal to the axial length of the protruding portion 92. However, the length of the insulating paper in the longitudinal direction may be shorter than the axial length of the protruding portion. The length of the insulating paper in the longitudinal direction may be longer than the axial length of the protruding portion.

In each of the above embodiments, in the stacking direction of the laminated core 10 or 110, the end portion 21 of the insulating paper 20 protrudes from the slot 14 of the laminated core 10 or 110 in the stacking direction. However, the end portion of the insulating paper in the stacking direction may not protrude from the slot in the stacking direction. The insulating paper 20 may protrude from the slot 14 in the stacking direction immediately after the laminated core 10 or 110 is manufactured by the stacking step S3 or S13, and then a portion protruding from the slot may be cut off.

In each of the above embodiments, the end portion 21 of the insulating paper 20 in the stacking direction protrudes in the axial direction from the slot 14 of the laminated core 10 or 110. However, the end portion of the insulating paper 20 in the stacking direction may be bent toward the outside of the slot when the stator is viewed in the stacking direction.

As a result, the end portion 21 in the stacking direction of the insulating paper 20 is easily caught by the end in the stacking direction of the laminated core 10 or 110. Therefore, it is possible to make it difficult for the insulating paper 20 to come off in the stacking direction from the inside of the slot 14 of the laminated core 10 or 110.

The end portion 21 of the insulating paper 20 in the stacking direction may be bent toward the inside of the slot 14 when the stator is viewed in the stacking direction. Accordingly, when the stator is manufactured, the insulating paper 20 can be easily mounted on the roll member 9.

In the mounting step S2 or S12 of each of the above embodiments, the insulating paper 20 having a length equivalent to the axial length of the protruding portion 92 is mounted on the protruding portion 92. That is, in a state where the insulating paper 20 is mounted on the protruding portion 92, the end portion 21 in the longitudinal direction of the insulating paper 20 is located at the position of the axial end of the protruding portion 92. However, in the mounting step, the insulating paper 20 longer than the axial length of the protruding portion 92 may be mounted on the protruding portion 92. In this case, a portion of the insulating paper located at an axial end of the central axis Q of the roll member may be mounted on the protruding portion in a state of being bent outward on the opposite side to the protruding portion.

As a result, since the bent portion at the axial end of the insulating paper inserted into the slot is caught by the laminated core, it is possible to make it difficult for the insulating paper to come off in the axial direction with respect to the laminated core.

Further, in the mounting step, a portion of the insulating paper located at an axial end of the central axis Q of the roll member may be mounted on the protruding portion in a state of being bent toward the protruding portion. Thus, the insulating paper can be easily mounted on the roll member.

In the first embodiment, the laminated core 10 includes one strip member 11. However, the laminated core may have two or more than two strip members. In this case, the surfaces of the plurality of strip members may not be aligned in one direction.

In the second embodiment, the laminated core 110 includes two strip members 121 and 122. However, the laminated core may have three or more than three strip members. In this case, the surfaces of the plurality of strip members may not be aligned in one direction.

In the pressing step S11 of the second embodiment, two iron core piece forming parts 71 are punched side by side. However, in the pressing step, three or more than three iron core piece forming parts may be punched side by side. In this case, in the stacking step S13, the surfaces of the plurality of iron core piece forming parts need not be aligned in one direction.

In the first embodiment, the stator 1 includes the laminated core 10 in which the strip members 11 extending spirally about the central axis P is stacked in the thickness direction. In the second embodiment, the stator includes the laminated core 110 in which two strip members 121 and 122 extending spirally about the central axis P are stacked in the thickness direction. However, the stator may include a laminated core in which plate-shaped steel sheets are stacked in the thickness direction.

That is, the stator may be a stator including a laminated core and insulating paper. The laminated core includes a cylindrical core back portion, and a plurality of tooth portions extending radially inward from a radially inner peripheral side of the core back portion, and steel sheets are laminated in a thickness direction. The insulating paper is accommodated in a slot located between the tooth portions. In this case, one surface in the thickness direction of the steel sheet has a curved surface portion at an end, and the other surface in the thickness direction of the steel sheet has a protrusion at an end. The one surface may be located on one side in the stacking direction of some of the steel sheets constituting the laminated core, and the other surface may be located on one side in the stacking direction of the others of the steel sheets constituting the laminated core.

The steel sheet stacked in the laminated core is formed by punching by pressing. Therefore, the steel sheet has a curved surface portion on one surface in the thickness direction and a protrusion on the other surface. The above-described laminated core can be formed by stacking surfaces of steel sheets formed by punching by pressing without aligning the surfaces in one direction in the stacking direction. Therefore, the laminated core that can be easily manufactured can be realized.

In addition, the surface located on one side in the stacking direction of the steel sheets constituting the laminated core includes one surface in the thickness direction having a curved surface portion at an end formed by punching by pressing and the other surface in the thickness direction having a protrusion at an end formed by punching by pressing. Therefore, as compared with the case where all the surfaces located on one side in the stacking direction of the steel sheets constituting the laminated core are one surfaces in the thickness direction having the curved surface portions, the insulating paper accommodated in the slot is less likely to come off to one side in the stacking direction. As a result, it is possible to realize a configuration in which the insulating paper can be more reliably held in the slot.

The present technique can also have configurations as described below.
(1) A stator manufacturing method is a method of manufacturing a stator that includes: a laminated core obtained by spirally winding a plate-shaped iron core piece forming part having a band-shaped back yoke forming portion and a plurality of tooth portions protruding from the back yoke forming portion to one side in a width direction of the back yoke forming portion while deforming the plate-shaped iron core piece forming part to one side in the width direction; and an insulating paper that is inserted into a slot located between the tooth portions. The stator manufacturing method includes a pressing step of punching the iron core piece forming part from a steel sheet by press molding, a mounting step of mounting the insulating paper on each of a plurality of protruding portions arranged in a circumferential direction on an outer peripheral surface of a columnar roll member rotating about a central axis and extending along the central axis, and a stacking step of spirally winding the iron core piece forming part around the outer peripheral surface of the roll member while deforming it in one direction in the width direction by rotating the roll member in a state where the protruding portion and the insulating paper are inserted into the slot, and stacking the iron core piece forming part in the thickness direction.
(2) In the stator manufacturing method according to (1), the pressing step includes punching a plurality of the iron core piece forming parts side by side from the steel sheet. The stacking step includes stacking the plurality of iron core piece forming parts in the thickness direction thereof by spirally winding the plurality of iron core piece forming parts around the outer peripheral surface of the roll member while deforming them in one direction in the width direction by the rotation of the roll member in a state where the plurality of iron core piece forming parts are overlapped in the thickness direction.
(3) In the stator manufacturing method according to (2), the stacking step includes stacking the plurality of iron core piece forming parts in the thickness direction thereof by spirally winding the plurality of iron core piece forming parts around the outer peripheral surface of the roll member while deforming them in one direction in the width direction by the rotation of the roll member in a state where the plurality of iron core piece forming parts are overlapped in the thickness direction in such a manner that one surfaces in the thickness direction having protrusions formed at ends of the plurality of iron core piece forming parts by the pressing step face each other or the other surfaces in the thickness direction having curved surface portions formed at ends of the plurality of iron core piece forming parts by the pressing step face each other.
(4) In the stator manufacturing method according to any one of (1) to (3), the mounting step includes mounting the insulating paper on the protruding portion in a state where a portion of the insulating paper located at an axial end of the central axis is bent outward to a side opposite to the protruding portion.
(5) A stator includes: a laminated core including a core back portion in a cylindrical shape and a plurality of tooth portions extending radially inward from a radially inner peripheral side of the core back portion, the laminated core having steel sheets stacked in a thickness direction; and insulating paper that is accommodated in a slot located between the plurality of tooth portions. One surface in the thickness direction of the steel sheet has a curved surface portion at an end, and the other surface in the thickness direction of the steel sheet has a protrusion at an end. The one surface is located on one side in the stacking direction of some steel sheets among the steel sheets constituting the laminated core, and the other surface is located on one side in the stacking direction of the other steel sheets among the steel sheets constituting the laminated core.
(6) In the stator according to (5), an end of the insulating paper in the stacking direction is bent outward of the slot when the stator is viewed in the stacking direction.
(7) In the stator according to (5) or (6), each of the steel sheets is a strip member that extends spirally about an axis and is capable of being stacked in the thickness direction. The laminated core is a lamination in which the steel sheets are laminated in the thickness direction.
(8) In the stator according to (7), the laminated core is a lamination in which the steel sheets are stacked in the thickness direction in a state of being overlapped in the thickness direction of the steel sheets.
(9) A motor includes the stator according to any one of (5) to (8).

The present invention is applicable to a method of manufacturing a stator in which insulating paper is accommodated in a slot.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator manufacturing method for a stator, the stator including
a laminated core obtained by spirally winding an iron core piece forming part in a plate shape while deforming the iron core piece forming part to one side in a width direction of a back yoke forming portion, the iron core piece forming part including the back yoke forming portion in a band shape and a plurality of tooth forming portions protruding from the back yoke forming portion to one side in the width direction of the back yoke forming portion, and
an insulating paper that is inserted into a slot located between the tooth forming portions, the stator manufacturing method comprising:
a pressing step of punching the iron core piece forming part from a steel sheet by press molding;
a mounting step of mounting the insulating paper on each of a plurality of protruding portions, the protruding portions being arranged in a circumferential direction on an outer peripheral surface of a roll member in a columnar shape that rotates about a central axis and extending along the central axis; and
a stacking step of spirally winding the iron core piece forming part around an outer peripheral surface of the roll member while deforming the iron core piece forming part in one direction in the width direction by rotating the roll member in a state where the protruding portion and the insulating paper are inserted into the slot, and stacking the iron core piece forming part in a thickness direction of the iron core piece forming part.

2. The stator manufacturing method according to claim 1, wherein
the pressing step includes punching a plurality of the iron core piece forming parts side by side from the steel sheet, and
the stacking step includes stacking the plurality of iron core piece forming parts in the thickness direction of the plurality of iron core piece forming parts by spirally winding the plurality of iron core piece forming parts around the outer peripheral surface of the roll member while deforming the plurality of iron core piece forming parts in one direction in the width direction by rotation of the roll member in a state in which the plurality of iron core piece forming parts are overlapped in the thickness direction.

3. The stator manufacturing method according to claim 2, wherein the stacking step includes stacking the plurality of iron core piece forming parts in the thickness direction of the plurality of iron core piece forming parts by spirally winding the plurality of iron core piece forming parts around the outer peripheral surface of the roll member while deforming the plurality of iron core piece forming parts in one direction in the width direction by the rotation of the roll member in a state in which the plurality of iron core piece forming parts are overlapped in the thickness direction in such a manner that one surfaces in the thickness direction having protrusions formed at ends of the plurality of iron core piece forming parts by the pressing step face each other or other surfaces in the thickness direction having curved surface portions formed at ends of the plurality of iron core piece forming parts by the pressing step face each other.

4. The stator manufacturing method according to claim 1, wherein the mounting step includes mounting the insulating paper on the protruding portion in a state where a portion of the insulating paper located at an axial end of the central axis is bent outward to a side opposite to the protruding portion.

5. A stator comprising:
a laminated core including a core back portion in a cylindrical shape and a plurality of tooth portions extending radially inward from a radially inner peripheral side of the core back portion, the laminated core having steel sheets stacked in a thickness direction; and
insulating paper that is accommodated in a slot located between the plurality of tooth portions, wherein
one surface in a thickness direction of each of the steel sheets has a curved surface portion at an end,
another surface in the thickness direction of each of the steel sheets has a protrusion at an end,
the one surface is located on one side in a stacking direction of some steel sheets among the steel sheets constituting the laminated core, and
the other surface is located on one side in the stacking direction of other steel sheets among the steel sheets constituting the laminated core.

6. The stator according to claim 5, wherein an end of the insulating paper in the stacking direction is bent outward of the slot when the stator is viewed in the stacking direction.

7. The stator according to claim 5, wherein
each of the steel sheets is a strip member that extends spirally about an axis and is capable of being stacked in the thickness direction, and
the laminated core is a lamination in which the steel sheets are laminated in the thickness direction.

8. The stator according to claim 7, wherein the laminated core is a lamination in which the steel sheets are stacked in the thickness direction in a state of being overlapped in the thickness direction of the steel sheets.

9. A motor comprising the stator according to claim 5.
